(19) United States
(12) Patent Application Publication
(10) Pub. No.: US 2002/0063132 A1
(43) Pub. Date: May 30, 2002

(54) Waste bench

(76) Inventors: Michael D. Prins, Grand Rapids, MI (US); Richard J. Vande Kopple, Belmont, MI (US); Brian G. Parker, Alto, MI (US); Dean T. Miller, Wyoming, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 09/931,455

(22) Filed: Aug. 16, 2001

Related U.S. Application Data
(60) Provisional application No. 60/225,550, filed on Aug. 16, 2000.
(60) Provisional application No. 60/270,740, filed on Feb. 22, 2001.

(51) Int. Cl. B65D 35/14; B65F 1/04

(52) U.S. Cl. 220/495.01; 220/908.1

(57) ABSTRACT

A waste bench for containing waste and/or recyclable materials in high density housing. The waste bench includes a sloped front wall to facilitate removal of contents from the bench and accommodate articles under the waste bench. The waste bench may also include one or more notches or slots in which necks of bags may be disposed so that those necks serve as pick-up flags to collection agency personnel. In another aspect, the bench includes a tiltable bin to easily access contents of the bench by tilting the bin forward to expose contents therein. Further, a latch that is actuatable from inside and outside the bin provides an added child-safety feature. Finally, the bench may include a label or a memory chip to provide information about the bench.

This application claims the benefit of U.S. Provisional Application No. 60/225,550, filed Aug. 16, 2000, and entitled RECEPTACLE DESIGNED FOR THE TEMPORARY STORAGE AND FREQUENT RETRIEVAL OF HOUSEHOLD WASTE AND RECYCLABLE MATERIALS and U.S. Provisional Application No. 60/270,740, filed Feb. 22, 2001, and entitled WASTE BENCH.

### BACKGROUND

The present invention relates to receptacles for the temporary storage of waste and/or recyclable materials.

In high density housing environments, such as apartment and condominium complexes, occupants commonly place household waste and/or recyclable materials in a hallway, breezeway or common area for pick-up by a waste or recyclable material collection agency. Typically, large rubber or plastic containers, for example, garbage cans and material bins are used to contain the waste and/or recyclable materials.

Although conventional garbage cans and material bins facilitate waste and/or recyclable material pick-up, use of these containers has its shortcomings. First, conventional garbage containers are bulky and consume a significant portion of useable space in hallways. In some cases, local ordinances prohibit the use of any container above a certain size for fire safety reasons. In such cases, the amount of waste and/or recyclable material able to be set out for pick-up by a collection agency is limited. Second, high density housing hallways that become cluttered with multiple waste containers and/or recyclable material bins frequently become unsightly and foul-smelling if the containers are not maintained or well-sealed. Third, the containers typically only have a single function, that is to store waste and/or recyclable materials. Finally, it is difficult for collection agency personnel to ascertain whether or not a particular garbage container contains waste unless she opens the container. Repeated investigation of container content by collection agency personnel can significantly increase the cost of waste collection.

### SUMMARY OF THE INVENTION

The aforementioned problems are overcome in the present invention which provides a waste or recyclable material receptacle in the form of a bench. The bench generally includes a lid, a bin, a removable liner disposed in the bin, and slots, notches or holes in the in the bin and/or liner for receiving the tops of trash bags to serve as a pick-up flag to collection agency personnel.

In a first aspect, the bench includes a lid and a bin. The bin includes a sloped front wall to facilitate removal of garbage therefrom and to accommodate footwear or other articles under the bench. The lid preferably includes a reticulated or reinforced rib structure to support the weight of individuals seated upon the bench. In this manner, the bench provides the dual function of waste and/or recyclable storage and a seating structure.

In a second aspect, the bin of the bench includes one or more slots, notches or holes for receiving the top of a trash bag to serve as a pick-up flag to collection agency personnel. In the preferred embodiment, the notches or slots are on the front wall of the bin of the bench to facilitate easy grasping and removal of the flag items. The slots or notches may be specifically configured to hold the tied neck portion of bags placed within the bench.

In a third aspect, the bench includes a child-safe lock that is actuatable from both inside and outside the bin of the waste bench.

In a fourth aspect, the bench includes a label or memory chip to identify or include information about the bench. In a preferred embodiment, the label or chip is readable by a corresponding reader so that collection agency personnel may form a record of collections from the waste bench.

In a fifth aspect, the bench includes a tiltable bin so that the bin may be tilted forward from a closed position in the bench to expose the contents of the bin, that is, bags of waste or recyclable materials therein.

These and other objects, advantages and features of the invention will be more readily understood and appreciated by reference to the detailed description of the preferred embodiments and the drawings.

### BRIEF DESCRIPTION OF THE DRAWINGS

FIG. 1 is a perspective view of the waste bench of the present invention;

FIG. 2 is a sectional view of the waste bench taken along lines 2-2 of FIG. 1;

FIG. 3 is an exploded view of the waste bench;

FIG. 4 is a sectional view taken along lines 4-4 of FIG. 1;

FIG. 5 is a linearly modular waste bench of the present invention;

FIG. 6 is a corner modular waste bench system of the present invention;

FIG. 7 is a sectional view of a first alternative embodiment of the waste bench;

FIG. 8 is a locking mechanism of the waste bench;

FIG. 9 is a second locking mechanism of the waste bench;

FIG. 10 is a third locking mechanism of the waste bench;

FIG. 11 is a perspective view of a second alternative embodiment of the waste bench;

FIG. 12 is a third alternative embodiment of the waste bench including a tiltable bin; and

FIG. 13 is a fourth alternative embodiment of the waste bench including a cylindrical container with a bag flag slot.

### DETAILED DESCRIPTION OF THE PREFERRED EMBODIMENTS

I. General Description

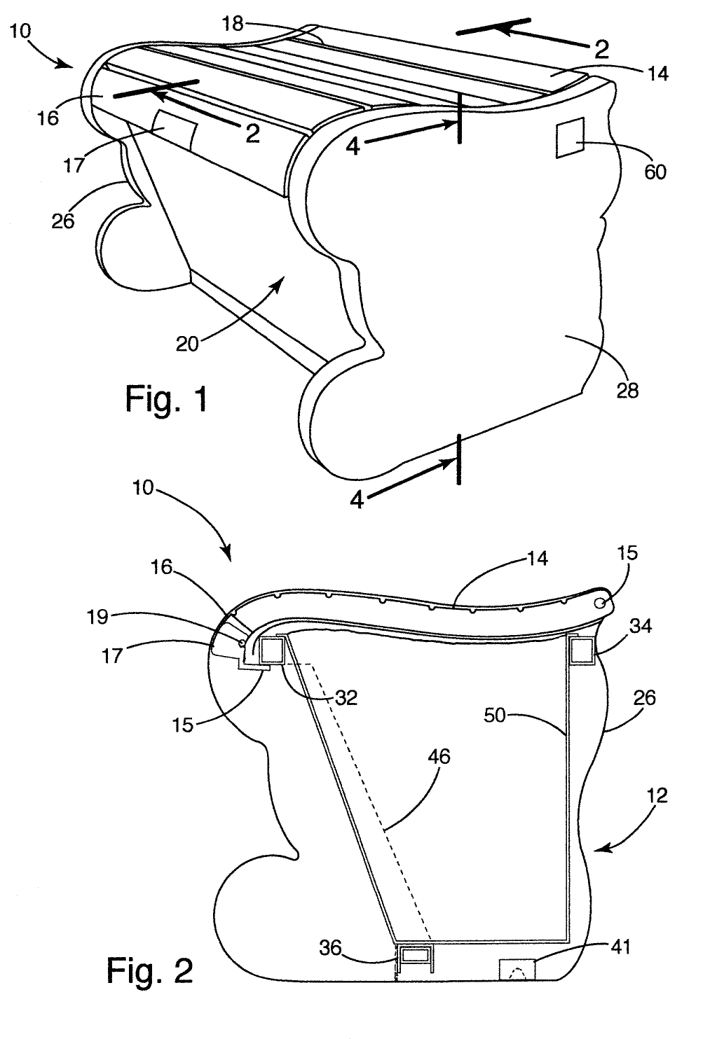

A receptacle for waste and/or recyclable materials, referred to as a waste bench, in accordance the first embodiment of the present invention is shown in FIGS. 1-4 and generally designated 10. The waste bench is preferably formed as a bench for seating so that it performs the dual function of holding waste, recyclables, and/or other materials, collectively referred to herein as “waste,” for collection and providing a seat. Optionally, the receptacle may be formed into other structures that may or may not provide dual functions. The waste bench generally includes a bin or compartment 20 and lid 14.

The lid and bin are preferably constructed from plastic, for example, polyethylene or polypropylene, although other types of plastic and other non-plastic materials may be used. Any conventional plastic manufacturing process may be used to manufacture the lid and bin, such as rotation molding and vacuum forming.

A. The Lid

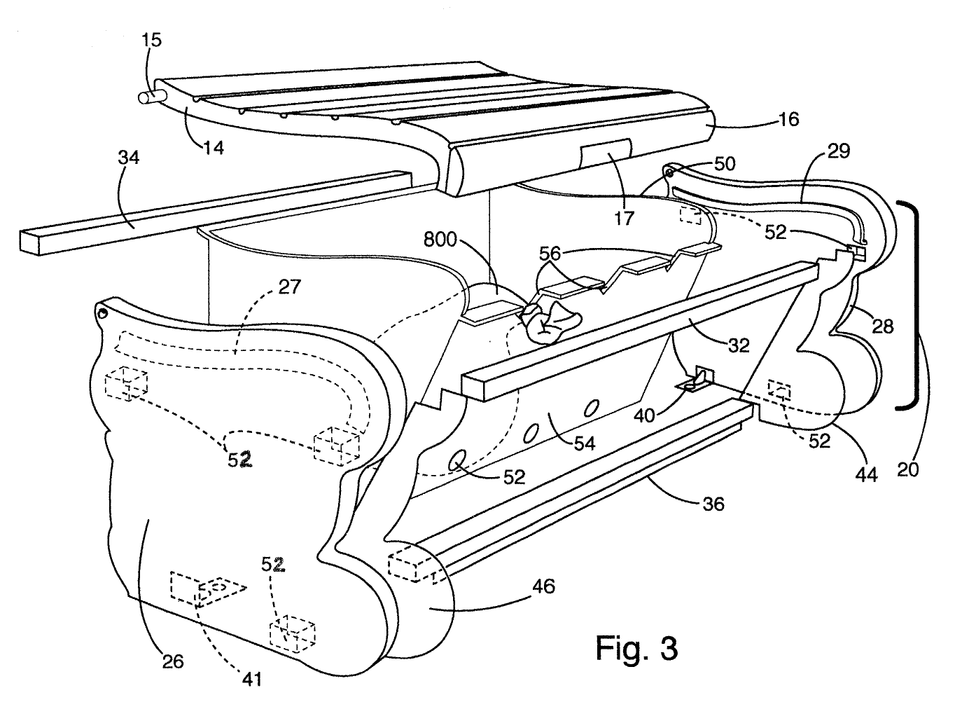

The lid as depicted in FIGS. 1-4 is preferably hingably attached to the bin at hinge 15. Hinge 15 may be any conventional hinge or optionally the bin and lid may be of a single piece with the hinge integrally molded to each. The lid 14 is preferably structurally reinforced so that it can withstand forces applied thereto and effectively transfer those forces to the bin 20 and subsequently the surface on which the waste bench 10 is placed. As depicted in FIG. 3, a preferred lid includes a reinforcing portion 16 which enhances the rigidity of the front of the lid. The remainder of the lid may include a reticulated or solid structure to enhance rigidity and strength as also shown. The lid optionally includes channels 18 to increase structure rigidity and facilitate liquids off from the lid toward side walls 26 and 28 of the bin 20.

B. The Bin

The bin 20 may be of a variety of configurations, one embodiment of which is depicted in FIGS. 1-4. There, the bin generally includes side walls 26 and 28 which are connected to one another with a frame or cradle. The cradle includes front frame member 32, rear frame member 34 and base frame member 36, which preferably are secured to the side walls 26 and 28. The frame members may be constructed of rigid plastic or metal to offer further structural support for the bin 20. Side walls 26 and 28 also may include any conventional reinforcement such as a waffle reticulated structure. Fitments 50 and 52 within the side walls 26 and 28 receive the frame members 32, 34 and 36. Frame members may be further secured to the fitments or the walls with commercially available fasteners such as screws, bolts and rivets. Optionally, the frame members 32, 34 and 36 may be integral with the side walls 26 and 28 to form a cradle-shaped structure.

Additional reinforcing members may also be added between the frame members 32, 34 and 36 and between the side walls 26 and 28. For example, support structures 44 and 46 are shown in FIG. 3. These supports provide additional strength across the front of the side walls 26 and 28 to support the frame member 32. Support is strategically placed to provide additional strength across the front of the bench where persons are likely to be seated.

Optionally, base frame member 36 may include a slot or other hole through which anchoring pins, bolts, screws or other fasteners may be positioned to anchor the waste bench to a surface. The base member may also be formed from two or more modular pieces that fit adjacent to one another thereby leaving a slot therebetween through which fasteners may be positioned to anchor the waste bench to a surface. Alternatively, side walls 26 and 28 may include fastening flanges 40 and 41, also referred to as feet, to secure the bench to a surface. As depicted, the feet 40 and 41 are capable of securing the side walls to the floor, however, other or additional flanges may be positioned on the side walls 26 and 28 or the frame members to secure the waste bench to other surfaces, such as a wall.

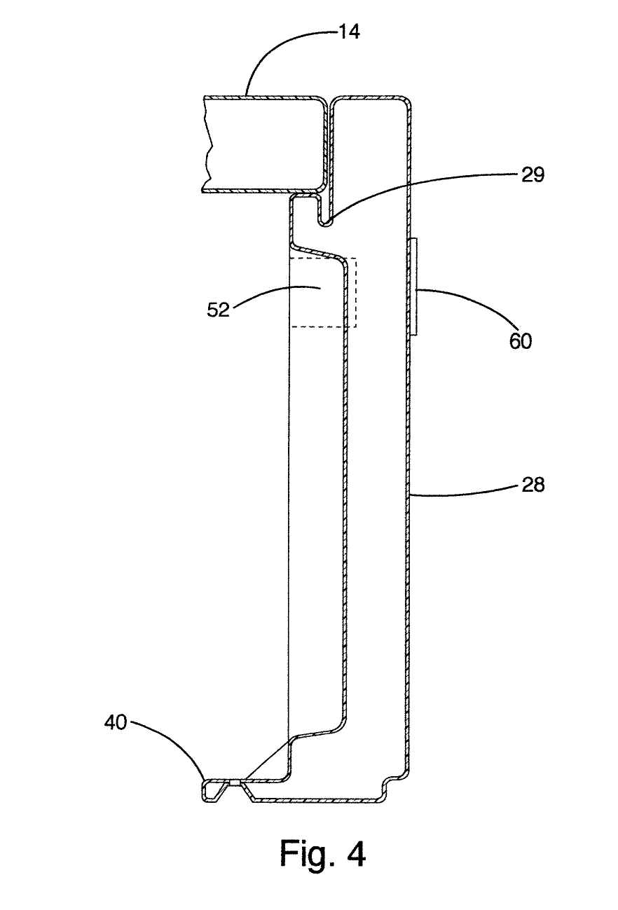

As best shown in FIGS. 3 and 4, side walls 26 and 28 may also include rain grooves 27 and 29 to prevent liquids channeled from the lid 14 toward the side walls 26 and 28 from seeping directly into liner 50, thereby wetting the contents therein. As depicted in FIG. 3, the rain grooves 27 and 29 may be arched or slanted to direct lid runoff to either the front of the waste bench or preferably to the rear of the waste bench 10.

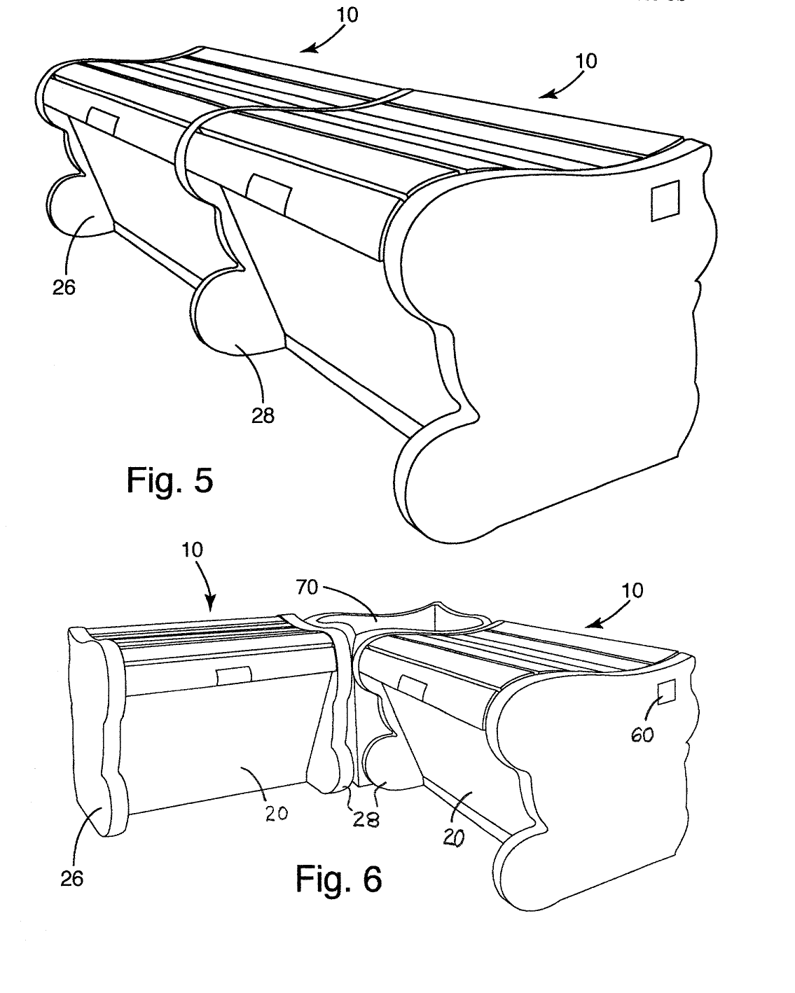

As shown in FIG. 5, the side walls 26 and 28 optionally may be configured with fitments (not shown) on two sides so that two waste benches may include a common side wall and linearly combined to form a single longer bench with two lids and two bins.

Multiple waste benches also may be combinable to form a shape that fits within a corner or conforms to an abnormally shaped wall. With reference to FIG. 6, the waste bench 10 may interfit with common piece 70, which for example may be shaped as a table or container to form an L-shape that fits in corners. The common piece 70 may be of any desired configuration to compliment the waste benches 10. Optionally, the end walls 28 and 29 adjacent the common piece 70 may be absent, and the waste bench bin 20 may be secured directly to the common piece 70.

As will be appreciated, the side walls 26 and 28 and/or the lid 14 may be outfitted with snap-on cupholders, ashtrays, magazine holders, or other amenities (not shown) as desired that clip on components of the waste bench 10 in a conventional manner.

The bin of the waste bench 10 also includes a liner 50 into which contents such as household or other waste or recyclable materials may be placed. The liner 50 may be of any configuration, and may further include multiple dividers to separate the liner into separate sub-compartments if desired (not shown).

In the first embodiment depicted in FIGS. 1-3, the liner preferably rests on base member 36 and abuts against or rests on the front member 32 for support. The liner 50 of the first embodiment waste bench preferably includes slots, slits, notches, holes, or other structures, collectively referred to herein as a “notch,” 54 capable of displaying a portion of an article, such as a bag 800 neck to passersby, preferably collection agency personnel, to indicate the bench includes contents that should be removed by collection agency personnel. As used herein. If desired, the front frame member 32 may have corresponding notches or like structures to allow a portion of the bag 800 to be exposed therethrough.

Preferably, the front wall 54 of the liner 50 may be of a slanted, sloped, inclined from the vertical, or arcuate shape to facilitate removal of contents from the liner 50, and to accommodate articles, such as footwear, disposed partially under the waste bench. The liner 50 may also include drain holes 52 to allow liquids from contents within the liner 50 to drain out and to facilitate cleaning of the liner 50.

Optionally, the waste bench includes an identifier 60 as depicted in FIGS. 1 and 4. The identifier 60 may be positioned on any component of the waste bench as desired, other than the side wall 28 as depicted. The identifier may be any conventional label or chip, such as a bar code label or a memory chip that stores information. A collection agency may use equipment to read the label or chip and form a record of collections from the waste bench. Optionally, the equipment may be used to download and store information on the chip as desired.

C. The Locking Mechanism

As shown in FIGS. 1-3, the waste bench also preferably includes a lock or latch 17 to keep the lid 14 in close relation to the bin 20. The latch shown in FIG. 2 pivots about pin 19 so that the catch 15 may engage and disengage front frame member 32. Of course, other components of the bin may be engaged by the catch as desired. The type of lock depicted in FIGS. 1 and 2 is referred to as an out-of-phase lock because it operates counter intuitive manner which requires 90° or 180° out-of-phase actions to disengage the lock and lift the lid 14. For example, the user must push down on the lock to disengage catch 15 and pull up on the lid simultaneously to open the lid. Accordingly, this type of lock requires an increased degree of manual dexterity to disengage, thereby keeping less dexterous beings, for example, children and animals from breaching the lock. As will be appreciated, many other locking or latching mechanisms, including out-of-phase and otherwise, may be employed as desired with the present invention. Several exemplary locks are depicted in FIGS. 8-10. These locks preferably are actuatable from both outside and inside the bin as an added safety feature, particularly for children. Optionally, this feature may be absent as desired.

The lock 217 of FIG. 8 is preferably secured to liner 50 via pivot 219. The lock may be actuated by pulling on portions 214 and 215 to disengage lid 14. Optionally, the lock may be secured to other components of the waste bench as desired, for example, a frame member (not shown) or side walls (not shown).

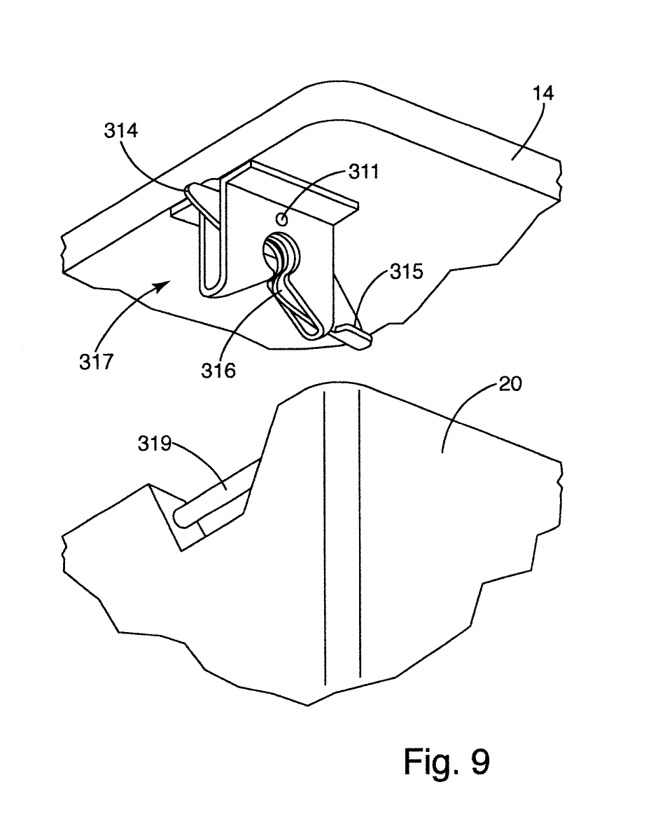

FIG. 9 shows another exemplary lock 317. The hook 316 of lock 317 engages bar 319 in a closed position. The hook pivots about pivot 311, and therefore may be disengaged by actuating either lever 314 or 315 from outside or inside bin 20 to deactivate the lock 317. As will be appreciated this exemplary lock may also be secured to other components of the waste bench as desired.

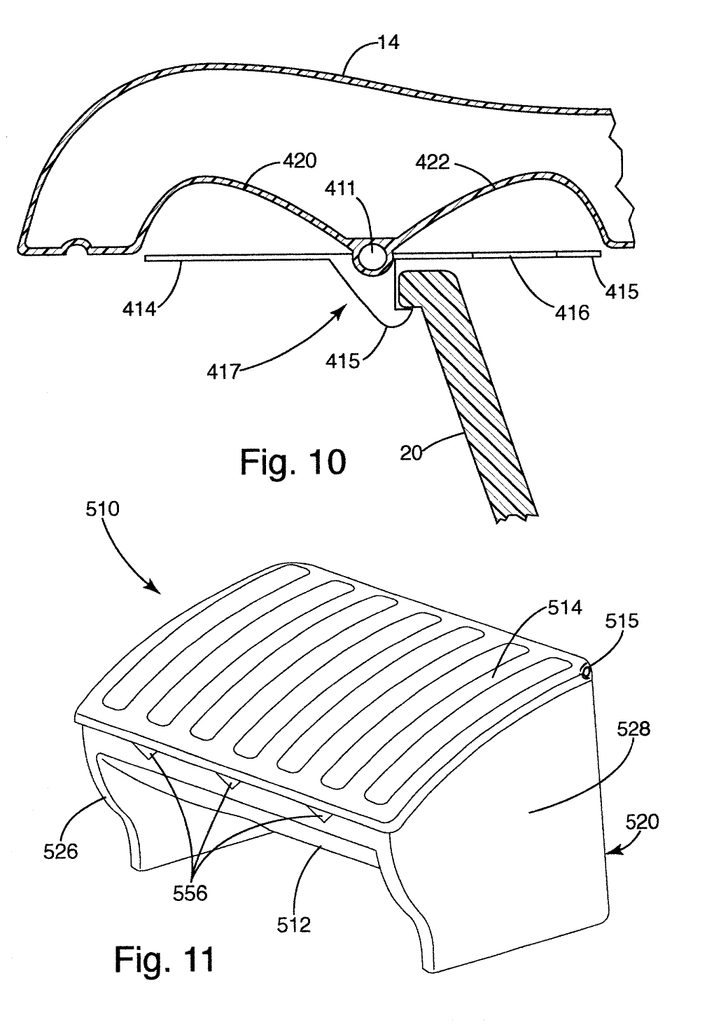

FIG. 10 depicts another exemplary lock 417 which is pivotally secured to lid 14 with pivot 411. Lid 14 preferably includes detents 420 and 422. The catch 415 may be disengaged from the bin component 20 by pushing lever 414 into detent 420 or pulling lever 415 out away from detent 422. Lever 415 may include a hand hole 416 to act as a handle to better grasp lever 415 from inside the bin 20. As will be appreciated, the lock 417 may be oriented in any configuration and engage any component of the waste bench as desired. As will further be appreciated, many alternatives exist to the locks described herein that may be substituted to achieve a desired function.

II. Alternative Embodiments

A. First Alternative Embodiment

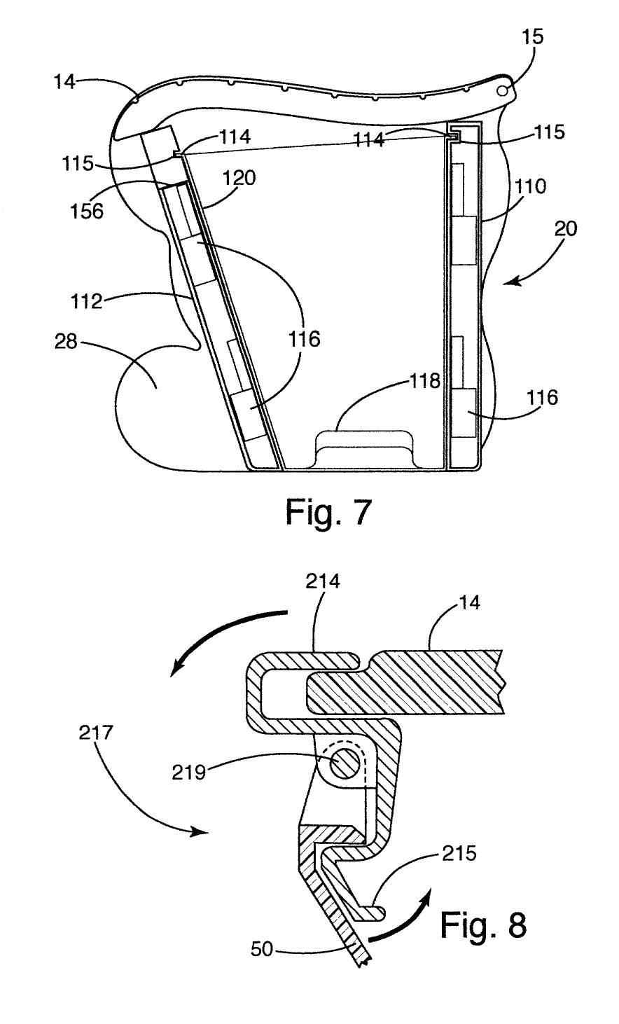

FIG. 7 shows a cross section of a first alternative embodiment of the waste bench of the first embodiment taken along lines 2-2 in FIG. 1. In this alternative embodiment, the waste bench generally includes a lid 14 hingably secured to the bin 20. On opposing sides of the waste bench are side walls, one of which, side wall 28, is shown in FIG. 7. The alternative embodiment depicted in FIG. 7 includes bin walls 110 and 112 that connect to form a structural frame with side walls 26 and 28. The bin walls 110 and 112 may include connector fittings 116 which interfit within corresponding fitments in the side walls similar in nature to that shown in FIG. 3. As will be appreciated, other fastening means may also be used.

Bin members 110 and 112 include grooves 114 to receive flanges 115 of the liner 112. Preferably, the liner 112 is of a semi-flexible or flexible material such as plastic so that the flanges 115 may readily snap fit into and out from the grooves 114. Optionally, the liner includes ridges 118 at its lowermost extremities to provide clearance for mounting features, for example, footings 40 and 41 (FIG. 3), on the side walls 26 and 28.

Preferably, the liner 120 and one or more of the bin members 110 and 112 includes notches and/or slots 156 through which the necks of bags 800 placed within the liner 120 may be disposed to indicate that the waste bench has contents therein.

B. Second Alternative Embodiment

A second alternative embodiment of the waste bench as depicted in FIG. 11 and generally designated 510. The waste bench includes a lid 514 pivotally or hingedly secured to bin portion 520 with a hinge 515 which may be any conventional hinge apparatus. The bin of the waste bench preferably includes a slanted or arced front wall 512, which facilitates removal of contents from the bin 520 of the waste bench. Preferably, the front wall 512 further includes notches or slots 556 or other structures to hold the neck portion of a bag or other article as a flag protruding from the waste bench 510. Optionally, these notches or slots may be disposed on side walls 526, 528 or in the lid 514 itself as the application requires. Preferably, the bin 520 of the waste bench is constructed from a single piece of plastic. It also may be constructed of individual pieces or components fastened together in any conventional manner. As will be appreciated, the additional components, for example, the lock, rain groove, structural reinforcements, and other components of the preferred embodiment may likewise be incorporated into this second alternative embodiment of the waste bench 510.

C. Third Alternative Embodiment

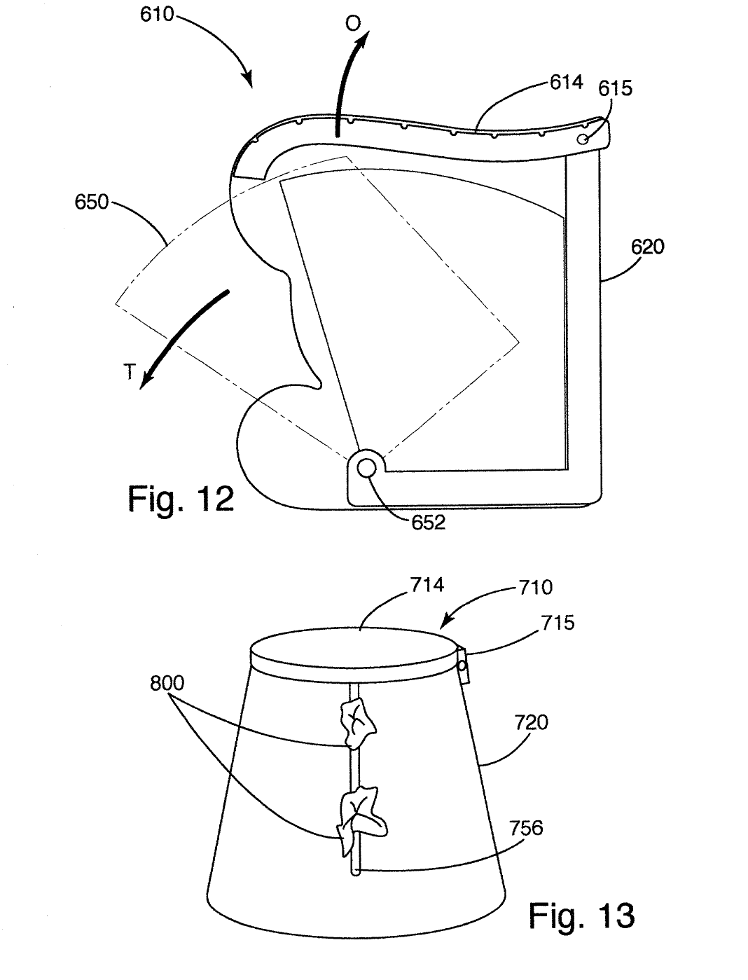

A third alternative embodiment of the waste bench is depicted in FIG. 12 and generally designated 610. The waste bench 610 includes a tiltable inner compartment 650 that pivots into and out from the bin structure 620 on pivot 652. The lid 614 is optionally hingably secured to the bin structure 620 via pivot 615 so that the lid may be opened in the direction of arrow O. As will be appreciated, the lid 614 may also be rigidly secured to the bin structure 620 so that the lid is not openable with respect to the bin. As will be appreciated, the tiltable inner compartment 650 may be pivotally secured to the bin structure 620 or any component thereof as the application requires. The bin structure 620 may also be slidably received within the waste bench 610 on a track system so that it slides into and out from bin structure 620.

D. Fourth Alternative Embodiment

FIG. 13 depicts a fourth alternative embodiment of a waste bench of the present invention and generally designated 710. This waste bench is generally cylindrical in nature and includes a lid portion 714 hingably secured to bin 720 by way of a conventional hinge 715. The bin further includes a vertical slot 756 in which the neck portions of bags or containers placed therein 800 may be positioned to act as a flag to collection agency personnel that the waste bench 710 includes removable contents therein.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A receptacle for waste comprising:
a bin including a front wall that is inclined from the vertical, an interior and an exterior;
a cover coupled to said bin forming a seating surface;
a latch to hold said cover in closed relation to said bin, said latch operable from said interior and said exterior; and
means for receiving a portion of an article located primarily within said interior making the portion visible from said exterior as a pick-up flag.

2. The receptacle of claim 1 wherein said receiving means is at least one of a slot, a notch and a hole.

3. The receptacle of claim 2 wherein said at least one of said slot, notch and hole are disposed in said front wall.

4. The receptacle of claim 3 comprising a liner disposed in said bin.

5. The receptacle of claim 1 wherein said cover is a lid hingedly attached to said bin.

6. The receptacle of claim 5 wherein said lid is reinforced with structural supports to withstand forces applied to the lid.

7. The receptacle of claim 1 comprising a frame, said bin tiltably mounted to said frame so that said bin may be tilted out from underneath said cover.

8. The receptacle of claim 1 comprising a frame, said bin slideably mounted to said frame so that said bin may be slid out from underneath said cover.

9. The receptacle of claim 1 wherein said bin is coupled to at least one end wall, said end wall including fittings to connect the receptacle to other receptacles.

10. The receptacle of claim 9 wherein the receptacle may be connected to other receptacles with said end wall in at least one of a linear configuration and a perpendicular configuration.

11. A receptacle comprising:
a cradle;
a bin pivotally coupled to said cradle including a front wall that is arcuate or inclined from the vertical;
a lid hingedly connected to at least one of said cradle and said bin, said lid openable with respect to said bin, said lid shaped in the form of a bench.

12. The receptacle of claim 11 comprising a removable liner disposed in said bin.

13. The receptacle of claim 11 wherein at least one of said cradle, bin and lid defines at least one of a slot, a hole and a notch to capture a portion of a bag and display the portion as a visual indicator that the receptacle contains a bag therein.

14. The receptacle of claim 13 wherein said bin defines at least one drain hole.

15. The receptacle of claim 11 comprising means for identifying the receptacle as distinct from other receptacles.

16. The receptacle of claim 15 wherein said identifying means is a bar code.

17. The receptacle of claim 15 wherein said identifying means is a memory chip, said chip capable of recording a collection record of the receptacle and outputting said collection record.

18. The receptacle of claim 11 wherein said cradle includes at least one foot, said foot including an anchoring flange so that said cradle may be secured to at least one of a floor and a wall.

19. The receptacle of claim 18 wherein said lid includes channels to facilitate liquid off from said lid.

20. The receptacle of claim 11 wherein said liner snap fits into said bin.

21. The receptacle of claim 11 wherein said bin includes a peripheral member upon which said lid rests when said lid is in a closed position, said peripheral member including at least one of a slant and a slope so that any liquid disposed thereon is directed away from said bin.

22. The receptacle of claim 11 comprising a lock to hold said lid in a closed position, said lock actuatable from inside the bin.

23. A receptacle bench comprising:
a bin including at least one notch to receive a portion of an article placed in said bin enabling the portion to act as a flag to viewers of the receptacle bench, indicating that an article is in the receptacle bench; and
a lid disposed over said bin.

24. The receptacle bench of claim 23 wherein said bin includes a removable liner.

25. The receptacle bench of claim 24 wherein said lid is operable between an open position and a closed position.

26. The receptacle bench of claim 23 wherein said lid maintains a static disposition and said bin is tiltable from horizontal.

27. The receptacle bench of claim 26 wherein said bin is tiltable to a closed position and an open position with respect to said lid so that any contents of said bin may be accessed by a user.

28. The receptacle bench of claim 23 wherein said bin includes a front wall, said front wall sloped to facilitate removal of contents therefrom.

29. The receptacle bench of claim 23 comprising at least one of an identification chip and an identification label.

30. The receptacle bench of claim 23 comprising a common piece for joining the receptacle bench to at least one other receptacle bench.

31. The receptacle bench of claim 30 wherein said joinder piece joins the receptacle bench to at least one other receptacle bench in at least one of a linear and perpendicular configuration.

32. The receptacle bench of claim 23 comprising a latch actuatable from inside the receptacle bench and outside the receptacle bench.

33. The receptacle bench of claim 23 comprising modular base panel, securable to at least one of said plurality of walls, said modular base panel defining at least one of a hole and a slot through which an anchor bolt is disposable.

34. The receptacle bench of claim 25 wherein at least one of said plurality of walls includes a surface aberration; said surface aberration for releasably securing at least one liner within said bin.

35. The receptacle bench of claim 34 wherein comprising a liner that securably interfits in said bin.

36. A waste bench comprising:
a compartment;
a cover operable between an open position and a closed position restricting or enabling access to said compartment; and
a locking mechanism operable from both inside said compartment and outside said compartment.

37. The waste bench of claim 36 comprising a removable liner that interfits in said compartment.

38. The waste bench of claim 37 comprising means for indicating that said compartment includes a bag therein by selectively exposing a portion of the bag.

39. A bench comprising:
a liner including a plurality of walls, one of said walls of a shape selected from the group consisting of sloped, slanted, inclined from vertical and arcuate to facilitate removal of articles from said liner; and
a lid disposed over said liner, said lid moveable between a closed lid position and an open lid position, said lid shaped to form a seating surface.

40. The bench of claim 39 comprising a latch to keep said lid in said closed lid position, said latch actuatable from a first location inside said liner and a second location outside said liner.

41. The bench of claim 39 wherein at least one of said walls and said lid defines at least one of a hole, a slot and a notch to display a portion of an article disposed in said liner to passersby when said lid is in said closed lid position.

42. The bench of claim 39 comprising a frame, said liner coupled to said frame so that said liner is tiltable from a closed liner position beneath said lid to an open liner position to expose an interior of said liner.

43. The bench of claim 39 comprising at least one of an identification chip and an identification label to provide information about the bench.
